(19) United States
(12) Patent Application Publication
(10) Pub. No.: US 2006/0268906 A1
(43) Pub. Date: Nov. 30, 2006

(54) Distribution of performance information for wireless networks

(76) Inventor: Jarkko Kneckt, Espoo (FI)

Correspondence Address: BRAKE HUGHES PLC;c/o PORTFOLIOIP, c/o PORTFOLIOIP, P.O. BOX 52050, MINNEAPOLIS, MN, 55402, US

(21) Appl. No.: 11/440,207

(22) Filed: May 24, 2006

Related U.S. Application Data
(60) Provisional application No. 60/685,440, filed on May 27, 2005.

(51) Int. Cl. H04L 12/28

(52) U.S. Cl. 370/401; 370/328; 370/338

(57) ABSTRACT

Various techniques are disclosed for the distribution of performance information in a wireless network, such as a wireless meshed network. In a first embodiment, a wireless node, such as a wireless mesh point, may obtain performance information and then transmit a wireless beacon including the performance information. The performance information may include, for example, mesh point performance information and station performance information. One or more other wireless mesh points in the network may receive the performance information via the wireless beacon and may perform access control and/or packet forwarding based, at least in part, on the received performance information.

### CROSS-REFERENCE TO RELATED APPLICATION

This application claims priority to U.S. Provisional application Ser. No. 60/685,440, filed on May 27, 2005, entitled “Distribution of Performance Information for Meshed Wireless Networks,” hereby incorporated by reference.

### BACKGROUND

The rapid diffusion of Wireless Local Area Network (WLAN) access and the increasing demand for WLAN coverage is driving the installation of a very large number of Access Points (AP). It can be useful to provide a wireless node with information relating to the performance of other aspects of the wireless network. A draft specification from the IEEE 802.11k Task Group, entitled “802.11 Amendment 7: Radio Resource Measurement,” has proposed the use of performance or measurement information for a link or a node. According to that draft specification, a station may report measurement or performance information to an Access Point (AP). These station reports may include measurements or reports for different performance parameters including packet delay, packet loss, link quality, traffic load, etc. for the link between the AP and the reporting station. These station reports may be provided to the AP upon request or when one of the performance parameters as measured by the station reaches some predetermined threshold.

The concept of a wireless meshed network of APs or other wireless nodes is also being considered. A wireless meshed network may be considered to be a collection of mesh points (MPs) interconnected via wired or wireless links. Each MP may typically be an Access Point, but may also be a station or other wireless node. However, in some cases, the IEEE 802.11k proposal may not adequately address the needs and complexities of wireless networks, such as a wireless meshed network.

### SUMMARY

Various techniques are disclosed for the distribution of performance information in a wireless network, such as a wireless meshed network.

In an example embodiment, a wireless node, such as a wireless mesh point, may obtain performance information and may transmit a wireless beacon including the performance information. The performance information may include, for example, mesh point performance information and station performance information. The mesh point performance information may be obtained, for example, by the mesh point measuring one or more performance parameters, such as: packet delay, packet loss, packet loss ratio, link quality, traffic load, received signal strength, packet errors, packet retransmissions, packet delay in buffer or transmission queue, and the like. The station performance information may be obtained by receiving station reports from wireless stations.

According to another example embodiment, one or more other wireless mesh points in the network may receive the performance information via the wireless beacon and may perform access control and/or packet forwarding based, at least in part, on the received performance information.

According to another example embodiment, a beacon message may be received by a receiving wireless node, the beacon message including network performance information obtained by a transmitting network node. Traffic access control may be performed based, at least in part, on the network performance information received from the transmitting network node.

According to another example embodiment, a beacon message may be received by a receiving wireless node, the beacon message including network performance information obtained by a transmitting network node. Packet routing or forwarding may be performed based, at least in part, on the network performance information received from the transmitting network node.

In another example embodiment, an article is provided that includes a storage medium. The storage medium may include stored thereon instructions that, when executed by a processor, result in obtaining performance information at a wireless node, and transmitting a beacon from the wireless node, the beacon including the performance information.

In another example embodiment, an apparatus is provided that includes a controller, a memory coupled to the controller, and a wireless transceiver coupled to the controller. The apparatus may be adapted or configured to obtain or measure network performance information, and to transmit a wireless beacon comprising the performance information.

In another example embodiment, a wireless mesh network may include a first mesh point configured to obtain or measure network performance information, and to transmit the network performance information in a wireless beacon, and a second mesh point configured to receive the wireless beacon from the first mesh point including the network performance information, the second mesh point to perform access control and/or to forward packets, at least in part, based on the received network performance information.

In another example embodiment, one or more performance parameters may be measured at a node in a wireless network. A determination may be made that at least one of the performance parameters has exceeded a predetermined threshold. A message may be sent reporting the measured performance parameters based on the determination.

These are merely a few examples, and the disclosure is not limited thereto.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating a wireless meshed network according to an example embodiment.

FIG. 2 is a flow chart illustrating operation of a wireless node according to an example embodiment.

FIG. 3 is a flow chart illustrating operation of a wireless node according to another example embodiment.

FIG. 4 is a flow chart illustrating operation of a wireless node according to yet another example embodiment.

FIG. 5 is a flow chart illustrating operation of a wireless node according to yet another example embodiment.

FIG. 6 is a block diagram illustrating an apparatus that may be provided in a wireless node according to an example embodiment.

### DETAILED DESCRIPTION

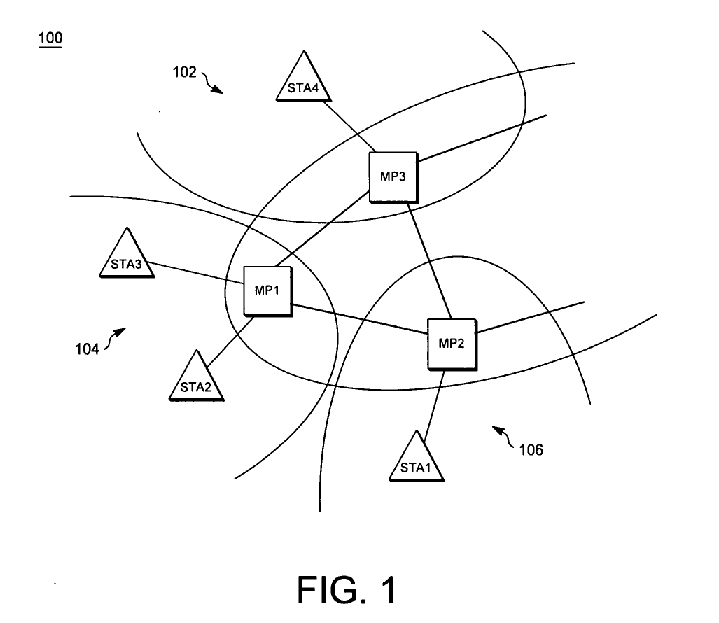

Referring to the Figures in which like numerals indicate like elements, FIG. 1 is a diagram illustrating a wireless meshed network 100 according to an example embodiment.

According to an example embodiment, a wireless meshed network may be a collection of mesh points (MPs) interconnected via wired or wireless links. Each MP may typically be an Access Point, but may also be a station or other wireless node. For example, a wireless meshed network may employ either a full mesh topology or a partial mesh topology. In a full mesh topology, each node (or mesh point) may be connected directly to each of the other MPs via a wired or wireless link. In a partial mesh topology, the mesh points may be connected to some but not necessarily all of the other mesh points in the meshed network.

The various embodiments described herein may be applicable to a wide variety of networks and technologies, such as WLAN networks (e.g., IEEE 802.11 type networks), IEEE 802.16 WiMAX networks, WiMedia networks, Ultra Wide Band networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wired or wireless networks, both in an infrastructure mode where an AP or base station may communicate with a station (e.g., communication occurs through APs), as well as an ad-hoc mode in which wireless stations may communicate directly via a peer-to-peer network, for example.

The term “wireless node,” “network node,” or “node,” or the like, may include, for example, a wireless station, such as a mobile station or subscriber station, an access point (AP) or base station, a relay station, a wireless personal digital assistant (PDA), a cell phone, an 802.11 WLAN phone, a WiMedia device, a WiMAX device, a wireless mesh point, or any other wireless device. These are merely a few examples of the wireless devices and technologies that may be used to implement the various embodiments described herein, and this disclosure is not limited thereto.

In the example wireless meshed network 100 illustrated in FIG. 1, mesh points MP1, MP2 and MP3 are inter-connected via wireless or wired links. Also, each mesh point (MP) may be coupled to one or more wireless stations in its local cell. For example, MP1 is located in cell 104 and is connected via wireless or wired links to stations STA2 and STA3 within cell 104. MP2 is located in cell 106 and is connected via wireless or wired link to stations STA1. MP3 is located in cell 102 and is connected via wireless or wired link to station STA4. Network 100 (including MP1, MP2 and MP3) may be considered a wireless distribution system. Wireless meshed network 100 is merely an example network and the disclosure is not limited thereto.

In an example wireless meshed network, each MP may be capable of many-to-many connections, and may be capable of learning network topology, dynamic path configuration, and other network capabilities, although the disclosure is not limited thereto. Each MP may also be mobile or be capable of being moved or movable, and may be capable of dynamically reconfiguring itself, although the disclosure is not limited thereto.

Each MP may transmit a beacon or beacon message, and may receive beacon messages from other MPs. In an example embodiment, a beacon message may be a management or control message transmitted by a mesh point that provides information about the transmitting MP and/or enables other wireless stations or MPs to establish communications with the MP, although the disclosure is not limited thereto. A beacon message may include, for example, information such as the beacon interval, or amount of time between beacon transmissions, a timestamp, a network ID or SSID (service set identifier) identifying a specific WLAN network, an indication of the supported data rates, parameter sets or information about specific signaling methods that are supported, capability information (such as whether Wired Equivalency Privacy or WEP protocol is supported), and other information.

According to an example embodiment, a mesh point's (MP's) beacon message may further include a Network Performance field that may include: 1) MP performance information, and/or 2) station performance information.

The MP performance information may include different performance parameters as measured or detected by the MP, such as packet delay, packet loss, link quality, traffic load, etc. The MP may measure these performance parameters by observing communications, counting lost packets or packet retries, detecting or measuring link quality or received signal strength, measuring traffic load, measure average packet delay within the MP's buffers or transmission queues, etc. Therefore, in an example embodiment, the MP performance information in the Network Performance field provided by an MP, for example, in its beacon message, may describe the network performance as seen or measured by the MP. In an example embodiment, the MP performance information provided in the Network Performance field is not limited to describing the performance of one link between the measuring MP and a station. Rather, in an example embodiment, the MP performance information of the Network Performance field may describe the overall performance or condition as detected or measured by the MP, e.g., taking into account traffic from the various stations and MPs that may be in communication with the MP.

In addition, as described in greater detail below, the Network Performance field may also include station performance information, which, for example may provide or reflect or summarize the performance information that is reported to the MP by one or more stations, for example, via station reports.

Table 1 illustrates a format of a Network Performance field according to an example embodiment. As noted above, this field may be included in a MP's beacon message that is periodically broadcast to other MPs and stations. Bits 0-10 may provide MP performance information which may include network performance information based upon the MP's detections and measurements of various performance parameters. Bits 11-21 of the Network Performance field may provide station performance information. Bits 22-23 may be reserved.

TABLE 1
Network Performance Field For Beacon

| Bit 0 | 1-2 | 3-4 | 5-8 | 9-10 | 11 | 12-13 | 14-15 | 16-19 | 20-21 | 22-23 |
|---|---|---|---|---|---|---|---|---|---|---|
| MP | Current | Prev. | MP | No. of | Station | Current | Prev. | Station | No. of | Res |
| Service | MP | MP | Service | beacons | Service | station | station | Service | beacons | |
| defined | Service | Service | Code | in current | defined | Service | Service | Code | in current | |
| | Level | Level | | MP | | Level | Level | | station | |
| | | | | Service | | | | | Service | |
| | | | | Level | | | | | Level | |

Bits 0-10, the MP performance information of the Network Performance Field, will be described first. Referring to Table 1, Bit 0 may represent the MP Service Defined field, and this bit or field may be set to a value of 1 if the remaining bits for the MP performance information (bits 1-10) in the Network Performance field are defined or valid, and may have a value of 0 otherwise.

Bits 1-2 in the Network Performance field may represent the MP Service Level for the current, or most recent, beacon period. The MP Service Level may indicate, for example, the level of service available at the MP, and may be based upon one or more measured parameters or network performance criteria measured by the MP, such as packet delay, packet loss, link quality, traffic load. Therefore, the MP Service Level may indicate the level of service that may be available to other stations or MPs for forwarding or processing packets, etc.

For example, the MP Service Level, which may indicate a quality of service available by the MP, may be inversely related to the measured traffic load, e.g., a higher Service Level may correspond to a lower traffic load at the station, and a lower Service Level may correspond to a higher traffic load at the MP, but this may depend on convention or the notation that is used. Similarly, bits 3-4 may identify the MP Service Level for the previous beacon period, and this may allow another station or MP to detect any recent changes in the Service Level for the MP.

In an example embodiment, the MP Service Level may be based upon the traffic load at the MP or as measured by the MP, although one or more other network performance parameters may be used as the basis instead, such as packet loss, traffic delay, link quality, etc.

TABLE 2
MP Service Level for Network Performance Field

| Bit 0 | Bit 1 | Service Level Description |
|---|---|---|
| 0 | 0 | Very good Service (very good performance). E.g., low |
| | | traffic load conditions or less. |
| 0 | 1 | Good service (good performance). E.g., traffic load |
| | | conditions between low and medium traffic load. |
| 1 | 0 | Acceptable service (acceptable performance). E.g., traffic |
| | | load condition between medium and high traffic load. |
| 1 | 1 | Poor service (poor performance). E.g., traffic load |
| | | conditions at or above a high traffic load. (e.g., high or |
| | | very high traffic loads) |

Table 2 above illustrates an example format of a MP Service Level according to an example embodiment. The MP Service Level may provide a specific value of performance, e.g., traffic load value or a packet delay, etc., for the MP. Alternatively, the Service Level may provide a service level relative to known levels, e.g., specifying the Service Level with respect to low, medium, high and very high traffic load values or thresholds.

For example, as shown in Table 2, a very good service level, e.g., very good performance at the MP, may correspond to a low traffic load or less measured at the MP. A good service level may correspond to a traffic load between low and medium traffic load values. An acceptable service level, e.g., acceptable performance at the MP, may correspond to a traffic load between medium and high traffic loads at the MP. Further, a poor service level, e.g., poor performance at the MP, may correspond to a traffic load greater than or equal to the high traffic load value. The Service Levels in Table 2 are provided merely as an example and the disclosure is not limited thereto. Many other variations are possible.

In an example embodiment, the traffic load values, or thresholds, used as references for the example Service Levels of Table 2 may correspond to the following descriptions. This is merely an example description of traffic loads, and the disclosure is not limited thereto; many other descriptions of loads or other network performance parameters may be used:
a. Low Traffic Load: very little load has been detected and resources may be available for all Access Categories (ACs).
b. Medium Traffic Load: There are sufficient resources to transmit the highest priority ACs, but low ACs, such as best efforts traffic, may be experiencing some difficulties.
c. High Traffic Load: Nearly maximum traffic load. New streams may be discouraged or prohibited, e.g., high AC streams protected by Access control, with ACM bit set, such as voice or video traffic, may not be started within coverage of this MP.
d. Very High Traffic Load: Traffic load is at maximum load. Even high AC traffic, such as voice or video traffic, may be experiencing difficulty, not allowing new streams to start. No new streams may be started within coverage of this MP. For example, high AC streams protected by Access control, with ACM bit set, may not be started within coverage of this MP.

In one embodiment, the Service Level may include a general Service Level that describes a general service level for traffic for a plurality of, or for all, Access Categories (ACs). Alternatively, the Service Level may be specified on a per Access Category (AC) basis, and may be specified for one or more ACs, for all ACs subject to Access Control, or all ACs. Four example ACs may include AC0=Best efforts, AC1=Video probe, AC2=Video, and AC3=Voice, but these are merely examples and the disclosure is not limited thereto. A current MP Service Level and a previous MP Service Level may be specified for each of a plurality of ACs, e.g., current MP Service Level[AC0] as two bits, current MP Service Level[AC1] as two bits, current MP Service Level[AC1] as two bits and current MP Service Level[AC2] as two bits, and the same may be done for previous MP Service Levels. For example, each of the two bit Service Level values may specify the service level, or traffic load, at the MP for that specified AC.

Referring to the Network Performance Field in Table 1, bits 5-8 may represent a MP Service code or Reason code to provide additional performance details or service level details for specific performance parameters. Table 3 below illustrates an example format of a MP Service code according to an example embodiment. The MP Service code may, for example, provide one or more bits for each of a plurality of performance parameters, such as delay, packet loss, link quality, and load. The parameter values in the Service code may provide quantitative values or relative values for each measured or detected parameter, e.g., actual or a relative value for the measured delay, measured packet loss, measured link quality, load, etc.

TABLE 3
MP Service Code for Network Performance Field

| Bit 0 | Bit 1 | Bit 2 | Bit 3 |
|---|---|---|---|
| Delay | Packet Loss | Link quality | Load |
| requirements | ratio | | requirements |

Alternatively, the parameter values in the Service code in Table 3 may include one or more bits indicating, for each performance parameter, whether or not a specified criteria or condition has been met for that parameter. This example embodiment is shown in Table 3, where bit 0 may be set to 1 if the delay requirements have been exceeded, bit 1 may be set to 1 if the measured packet loss ratio exceeds a packet loss threshold, bit 2 may be set to 1 if the link quality decreases below a threshold, and bit 3 may be set to 1 if the measured load exceeds the load requirements. Also, the parameter values of the Service code may apply generally to a plurality of ACs or all ACs, or may be AC-specific, e.g., an AC-specific parameter value for each of a plurality of ACs. For example, the delay requirements, represented by bit 0, and the packet loss ratio, represented by bit 1, may be AC-specific, whereas the link quality and load requirements may be general parameters, e.g., applicable to a plurality of ACs, or to all ACs.

Referring again to Table 1, bits 9-10 of the Network Performance field may identify the number of beacon periods, or beacons, that the MP Service Level has been at this current value, according to an example embodiment.

| bit 0 | 1 | No. of Beacon periods |
|---|---|---|
| 0 | 0 | Less than 2 beacon periods |
| 0 | 1 | Less than 4 beacon periods |
| 1 | 0 | Less than 8 beacon periods |
| 1 | 1 | More than 8 beacon periods |

Referring to Table 1, Bits 11-21 of the Network Performance field may provide station performance information to other MPs and stations. According to an example embodiment, a MP may receive station reports from one or more stations, either through the 802.11k reporting technique or another technique. These station reports may provide performance parameters as measured or detected by these reporting stations for one or more performance parameters such as packet delay, packet loss, link quality, traffic load, etc. for the link between the MP and the reporting station. For example, these station reports may be provided by the station to the MP upon the MP's request or when one of the performance parameters as measured by the station reaches some predetermined threshold, or at some other point.

According to an example embodiment, a MP may receive station reports from one or more stations that are coupled to the MP. According to an example embodiment, the MP may include some or even all of the information it received in one or more station reports in the station performance information of the Network Performance Field of its beacon. This may allow the MP to provide other MPs and stations not only information about the MP's measured network performance, but also network performance information from the MP's 1-hop neighbor stations. This may provide other MPs with a clearer picture of the overall condition or status of the wireless meshed network.

The station performance information may be provided as bits 11-21 of the Network Performance field, for example, although the disclosure is not limited thereto. The station performance information may include, for example, station report information from one or more stations, a summary of the station report information, e.g., summarized for all of the received station reports or some of the reports, or may include summary information based on a certain number of the lowest performing stations, or may provide information from station reports only for specific Access Categories (ACs). The station performance information may be provided as general information, for example, describing or applicable to many ACs or all ACs, or may be provided on a per AC basis, as described above for the MP. The fields for bits 11-21, or station performance information of the Network Performance field may be similar to, or the same as, the bits 1-10 for the MP as described above, and are thus not described further.

When a MP or station first joins a wireless meshed network, the station or MP may associate with one or more MPs already in the network. As part of the Association, ReAssociation and Response messages, the existing MP may provide a bit map or other control message indicating which station reports may be provided to the MP, on a per AC basis. This map may also indicate which performance parameters may be reported out in the Network Performance field via the MP's beacon.

For example, the bit map or control message may identify that reports of the following performance parameters should be provided: number of sequential transmission errors[AC], delay limit[AC], packet loss ratio[AC], link quality, amount of traffic load, etc. The control message may also identify those ACs for which Access Control may apply for the MP, e.g., Access Control Mandatory bit may be set for these ACs. This control message from the MP may also specify the rule to decide the forwarding level for stations, such as the worst performance, average of N of the worst performance reports or average of all performance levels.

A control message from the MP to the other station or MP, e.g., a new station or MP associating with the MP, may also specify the criteria for the MP Service Code, or the threshold values or condition used for the MP Service Code, such as the values for the delay requirements, packet loss ratio, link quality, load requirements, etc. for the MP.

In an example embodiment, an MP or station may receive an MP's beacon message, including the Network Performance field, which may include the MP performance information and/or the station performance information. An MP or station receiving such a Network Performance field may make admission control decisions for traffic of different Access Categories (ACs) based on the MP performance information and/or the station performance information in the Network Performance field. For example, if the performance information in one or more MP's beacons indicates that one or more adjacent MPs have detected increasing traffic loads, the receiving MP may then start rejecting new high AC traffic requests to reduce the traffic load in the network.

The station or MP receiving one or more beacons may also make packet routing or forwarding decisions based on the MP and station performance information in the Network Performance fields of each of these beacons. For example, in the wireless meshed network of FIG. 1, MP1 may need to forward a packet to a remote station (not shown), and can forward this packet either through MP2 or MP3. However, the Network Performance fields in the beacons may be received by MP1 from MP2 and MP3. The Service Level in the beacon from MP2 may indicate that MP2 offers a good service level (good performance), e.g., indicating traffic load conditions for MP2 between low and medium traffic load. On the other hand, the Service Level received in the beacon from MP3 may indicate that MP3 offers a poor service level (poor performance), e.g., traffic load conditions at or above a high traffic load. Therefore, MP1 may forward the packet to MP2 because MP2 offers a much higher, or much better Service Level, e.g. decreased traffic load, as compared to MP3.

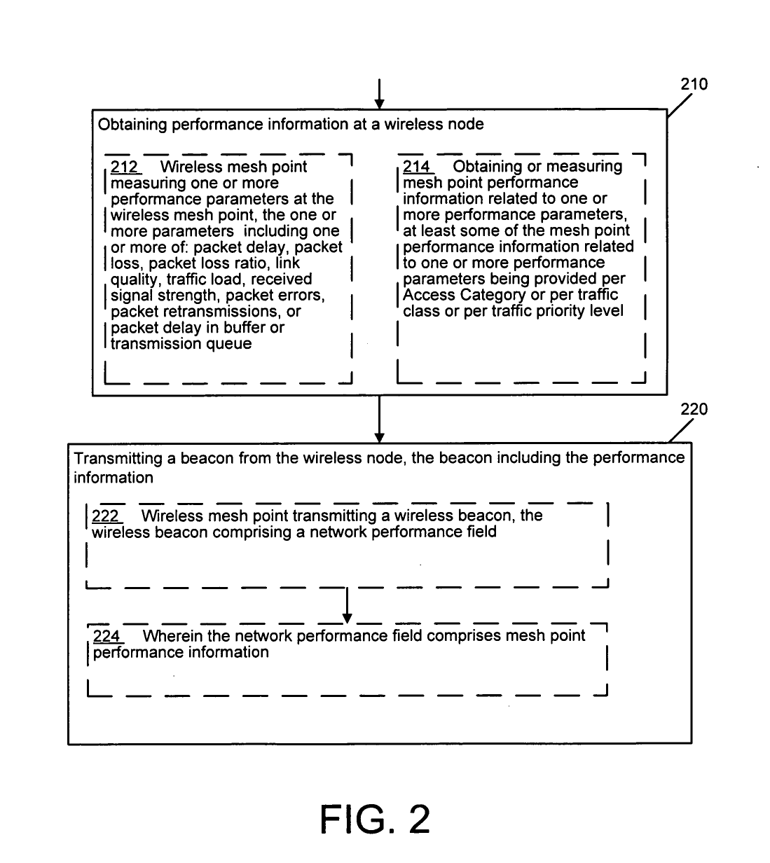

FIG. 2 is a flow chart illustrating operation of a wireless node according to an example embodiment. At 210, performance information may be obtained at a wireless node. At 220, a beacon may be transmitted from the wireless node, the beacon including the performance information.

The obtaining operation 210 may include, for example, operation 212 or 214. At operation 212, a wireless mesh point may measure one or more performance parameters at the wireless mesh point. The one or more parameters may include one or more of: packet delay, packet loss, packet loss ratio, link quality, traffic load, received signal strength, packet errors, packet retransmissions, or a packet delay in buffer or transmission queue, 212. At operation 214, mesh point performance information may be obtained or measured related to one or more performance parameters. In an example embodiment, at least some of the mesh point performance information related to one or more performance parameters may be provided per Access Category or per traffic class or per traffic priority level.

The transmitting operation 220 may include operation 222 and/or 224. At operation 222, a wireless mesh point may transmit a wireless beacon, the wireless beacon comprising a network performance field. Further, the network performance field may include mesh point performance information, operation 224. For example, the mesh point performance information may include information as discussed previously with regard to the information represented by bits 0-10 of the example network performance field as illustrated by Table 1.

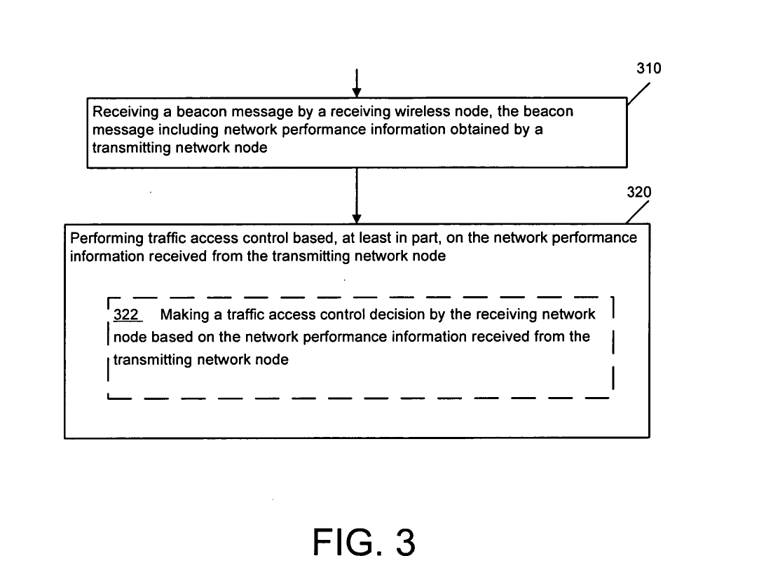

FIG. 3 is a flow chart illustrating operation of a wireless node according to another example embodiment. At 310, a beacon message may be received by a receiving wireless node, the beacon message including network performance information obtained by a transmitting network node. For example, the network performance information may include information included in a network performance field, e.g., as discussed previously with regard to the example network performance field as illustrated by Table 1.

At 320, traffic access control may be performed based, at least in part, on the network performance information received from the transmitting network node. Operation 320 may include operation 322, in an example embodiment. At operation 322, a traffic access control decision may be made by the receiving network node based on the network performance information received from the transmitting network node. For example, as discussed previously, if the performance information in one or more MP's beacons indicates that one or more adjacent MPs have detected increasing traffic loads, the receiving MP may then start rejecting new high AC traffic requests to reduce the traffic load in the network.

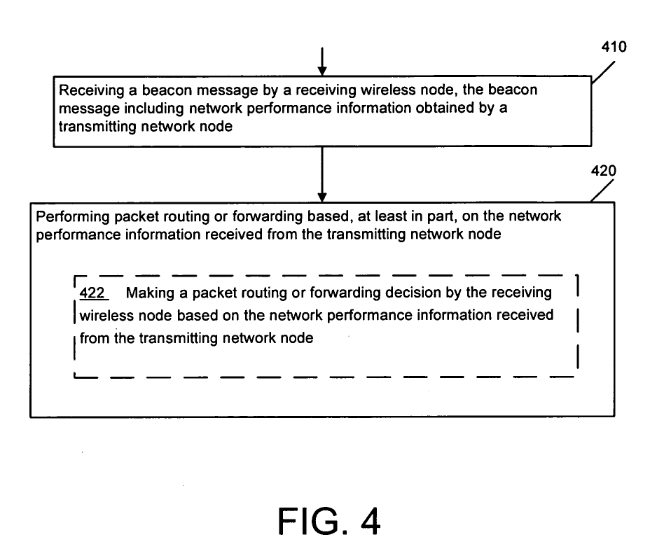

FIG. 4 is a flow chart illustrating operation of a wireless node according to yet another example embodiment. At 410, a beacon message may be received by a receiving wireless node, the beacon message including network performance information obtained by a transmitting network node. As discussed previously, the network performance information may, for example, include information such as that included in the example network performance field as illustrated by Table 1. As noted, the information illustrated in Table 1 is merely an example embodiment, and the disclosure is not limited thereto.

At 420, packet routing or forwarding may be performed based, at least in part, on the network performance information received from the transmitting network node. Operation 420 may include operation 422, according to an example embodiment. At operation 422, a packet routing or forwarding decision may be made by the receiving network node based on the network performance information received from the transmitting network node, 422. For example, and as discussed previously, based on received performance information, MP1 of FIG. 1 may forward a packet to MP2 because MP2 may offer a much higher, or much better Service Level, e.g. decreased traffic load, as compared to MP3.

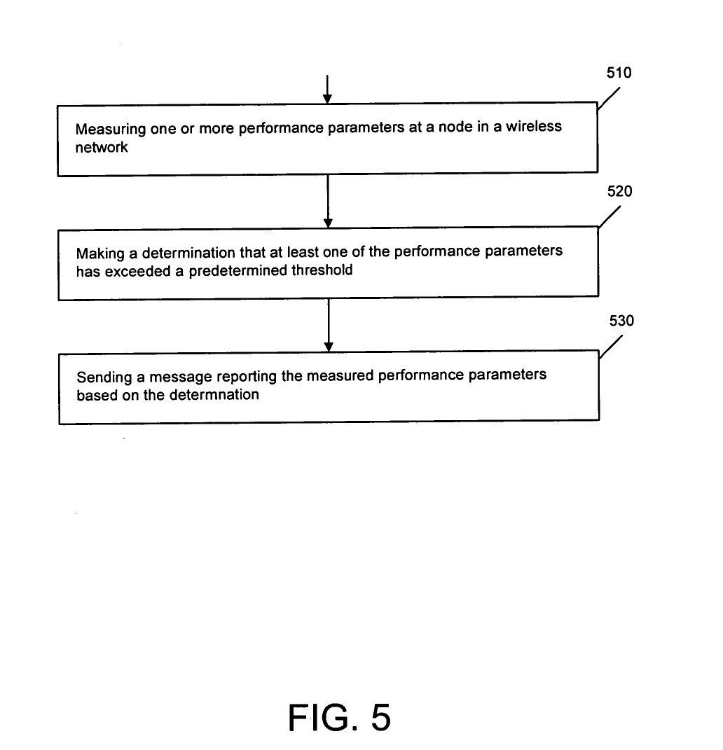

FIG. 5 is a flow chart illustrating operation of a wireless node according to yet another example embodiment. At 510, one or more performance parameters may be measured at a node in a wireless network. The one or more parameters may include, for example, one or more of packet delay, packet loss, packet loss ratio, link quality, traffic load, received signal strength, packet errors, packet retransmissions, or a packet delay in buffer or transmission queue as discussed with regard to FIG. 2, although the disclosure is not limited thereto.

At 520, a determination may be made that at least one of the performance parameters has exceeded a predetermined threshold. For example, the predetermined threshold may relate to degraded and/or improved performance for the particular measuring wireless node. At 530, a message may be sent reporting the measured performance parameters based on the determination. For example, the message may include an indication of signal congestion/poor performance, a request for permission to reduce an amount of traffic, a request for rerouting of traffic, although the disclosure is not limited thereto. Based on the determination, the measuring wireless node may reduce an amount of transmitted traffic, or may start measuring link performance.

Each mesh point (MP) may comprise a wireless transceiver, a processor or controller, and memory. Furthermore, more than one transceiver may be used e.g., for MP-to-MP traffic and MP-to-station traffic separately. Each MP may be programmed or adapted to perform the various functions or tasks described above. The MP controller may be programmable, and capable of executing software or other instructions stored in memory or on other computer media to perform the various tasks and functions described above.

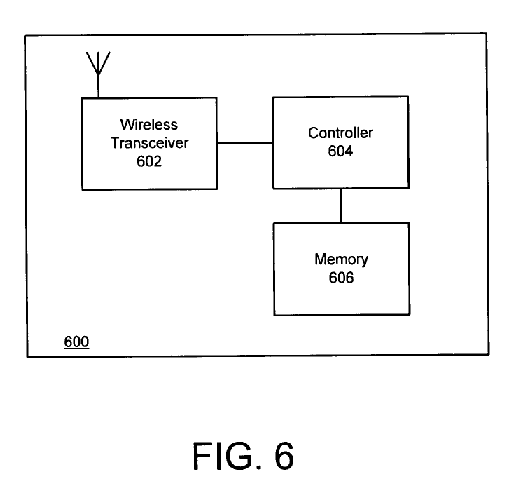

FIG. 6 is a block diagram illustrating an apparatus 600 that may be provided in a wireless node according to an example embodiment. The wireless node (e.g. station, MP, or AP) may include, for example, a wireless transceiver 602 to transmit and receive signals, a controller 604 to control operation of the station and execute instructions or software, and a memory 606 to store data and/or instructions.

Controller 604 may be programmable and capable of executing software or other instructions stored in memory or on other computer media to perform the various tasks and functions described above, such as one or more the tasks or methods described above in FIGS. 1-5.

In addition, a storage medium may be provided that includes stored instructions, when executed by a controller or processor, such as a mesh point processor, that may result in the controller 604, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) or methods described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the example embodiments have been illustrated as described herein, many modifications, substitutions, changes and equivalents will now occur to those skilled in the art. It is, therefore, to be understood that the appended claims are intended to cover all such modifications and changes as fall within the true spirit of the various example embodiments.

What is claimed is:

1. A method comprising:
obtaining performance information at a wireless node; and
transmitting a beacon from the wireless node, the beacon including the performance information.

2. The method of claim 1 wherein the obtaining comprises the wireless node obtaining or measuring one or more performance parameters relating to network performance at the wireless node or at another wireless station.

3. The method of claim I wherein the obtaining comprises a wireless mesh point measuring one or more performance parameters at the wireless mesh point.

4. The method of claim 3 wherein said wireless mesh point measuring comprises a wireless mesh point measuring one or more performance parameters at the wireless mesh point, the one or more parameters including one or more of:
packet delay;
packet loss;
packet loss ratio;
link quality;
traffic load;
received signal strength;
packet errors;
packet retransmissions; or
packet delay in buffer or transmission queue.

5. The method of claim 1 wherein the obtaining performance information comprises obtaining or measuring mesh point performance information related to one or more performance parameters.

6. The method of claim 5 wherein the obtaining or measuring comprises obtaining or measuring mesh point performance information related to one or more performance parameters, at least some of the mesh point performance information related to one or more performance parameters being provided per Access Category or per traffic class or per traffic priority level.

7. The method of claim 1 wherein the obtaining performance information comprises obtaining station reports from one or more wireless stations, the station reports providing performance information as measured by the wireless station relating to one or more performance parameters.

8. The method of claim 7 wherein the obtaining comprises obtaining station reports providing performance information as measured by the wireless station relating to one or more performance parameters, at least some of the performance information in the station reports being provided per Access Category or per traffic class or per traffic priority level.

9. The method of claim 1 wherein the obtaining performance information comprises:
measuring, at a wireless mesh point, network point performance information related to one or more performance parameters; and
the wireless mesh point obtaining station reports from one or more wireless stations, the station reports providing performance information measured by the one or more wireless stations relating to one or more performance parameters.

10. The method of claim 1 wherein the transmitting comprises a wireless mesh point transmitting a wireless beacon, the wireless beacon comprising a network performance field.

11. The method of claim 10 wherein the network performance field comprises mesh point performance information.

12. The method of claim 11 wherein said mesh point performance information comprises at least one of a mesh point service level and a mesh point service code.

13. The method of claim I wherein the obtaining comprises receiving a station report at the wireless node from a reporting wireless node relating to network performance of the reporting wireless node.

14. The method of claim 13 wherein the transmitting comprises transmitting a network performance field including at least one of a station service level and a station service code related to the network performance of the reporting wireless node.

15. A method comprising:
receiving a beacon message by a receiving wireless node, the beacon message including network performance information obtained by a transmitting network node; and
performing traffic access control based, at least in part, on the network performance information received from the transmitting network node.

16. The method of claim 15 wherein the performing traffic access control comprises making a traffic access control decision by the receiving network node based on the network performance information received from the transmitting network node.

17. A method comprising:
receiving a beacon message by a receiving wireless node, the beacon message including network performance information obtained by a transmitting network node; and
performing packet routing or forwarding based, at least in part, on the network performance information received from the transmitting network node.

18. The method of claim 17 wherein the performing packet routing or forwarding comprises making a packet routing or forwarding decision by the receiving wireless node based on the network performance information received from the transmitting network node.

19. An article comprising:
a storage medium;
said storage medium including stored thereon instructions that, when executed by a processor, result in:
obtaining performance information at a wireless node; and
transmitting a beacon from the wireless node, the beacon including the performance information.

20. The article of claim 19 wherein the instructions resulting in transmitting the beacon from the wireless node, the message including the performance information comprise instructions that, when executed by a processor result in:
a receiving wireless node performing traffic access control based, at least in part, on the transmitted performance information.

21. An apparatus comprising:
a controller;
a memory coupled to the controller; and
a wireless transceiver coupled to the controller;
the apparatus adapted to:
obtain or measure network performance information; and
transmit a wireless beacon comprising the performance information.

22. A wireless meshed network comprising:
a first mesh point configured to obtain or measure network performance information, and to transmit the network performance information in a wireless beacon; and
a second mesh point configured to receive the wireless beacon from the first mesh point including the network performance information, the second mesh point to perform access control and/or to forward packets, at least in part, based on the received network performance information.

23. A method comprising:
measuring one or more performance parameters at a node in a wireless network;
making a determination that at least one of the performance parameters has exceeded a predetermined threshold; and
sending a message reporting the measured performance parameters based on the determination.
